(19) United States
(12) Patent Application Publication
(10) Pub. No.: US 2026/0181116 A1
(43) Pub. Date: Jun. 25, 2026

(54) INFORMATION PROCESSING APPARATUS, INFORMATION PROCESSING METHOD, AND INFORMATION PROCESSING PROGRAM

(71) Applicant: FUJIFILM Corporation, Tokyo (JP)

(72) Inventor: Toshihiro OOGUNI, Saitama-shi (JP)

(73) Assignee: FUJIFILM Corporation, Tokyo (JP)

(21) Appl. No.: 19/543,565

(22) Filed: Feb. 18, 2026

Related U.S. Application Data
(63) Continuation of application No. PCT/JP2024/029243, filed on Aug. 19, 2024.

(30) Foreign Application Priority Data
Aug. 31, 2023 (JP) 2023-140988

(51) Int. Cl. H04N 9/31

(52) U.S. Cl. CPC H04N 9/3185; H04N 9/3164

(57) ABSTRACT

An information processing apparatus includes a processor. The processor is configured to: acquire first image data obtained by imaging a space; determine a position of a virtual projection apparatus in the space; acquire a plurality of projection points that are intersections between a plurality of projection rays of the virtual projection apparatus and an object in the space, and determine a position and a shape of a virtual projection surface based on the plurality of projection points; generate second image data representing a second image in which the virtual projection surface is displayed on a first image represented by the first image data; and output the second image data to an output destination.

### CROSS-REFERENCE TO RELATED APPLICATIONS

This is a continuation of International Application No. PCT/JP2024/029243 filed on Aug. 19, 2024, and claims priority from Japanese Patent Application No. 2023-140988 filed on Aug. 31, 2023, the entire content of which is incorporated herein by reference.

### BACKGROUND OF THE INVENTION

### 1. Field of the Invention

The present invention relates to an information processing apparatus, an information processing method, and a storage medium.

### 2. Description of the Related Art

JP2023-039885A discloses an installation simulation apparatus that acquires an installation place image of a place where a projector is installed, an installation position of the projector at the installation place, and a projection place image of a place where video of the projector is projected or of a place where a projection target of the video is installed, and displays one or both of an image in which an image of the projector is drawn at the projector installation position in the installation place image and an image in which a projection region image, indicating a region onto which the video is projected, is drawn in the projection place image.

JP2022-126127A discloses an information processing apparatus that acquires first information representing a three-dimensional shape of a room having a projection surface on which a first image is projected, displays a second image showing the three-dimensional shape of the room on a display device based on the first information, receives an operation of determining a projection range of the first image on the projection surface to acquire second information defining the projection range, and displays, by superimposing on the second image based on the first information and the second information, third information showing at least one of a number, a type, or an installation position of one or a plurality of projectors installed in the room for projecting the first image onto the projection range.

JP2021-158627A discloses a projector that includes a projection unit that projects image light onto a projection surface of a screen, an imaging unit that images a region including the projection surface, a projection control unit that causes the projection unit to project the image light onto the projection surface of the screen in which at least three markers are disposed along a curved projection surface in one direction to form a projection image, a generation unit that causes the imaging unit to image the projection image and the markers to generate a captured image, and an adjustment unit that adjusts a projection position such that a position of an outer edge of a projection region of the projection image substantially matches a position of the markers based on the captured image.

### SUMMARY OF THE INVENTION

One embodiment according to the technology of the present disclosure provides an information processing apparatus, an information processing method, and a storage medium that can more accurately simulate a projection state of a projection apparatus.

An information processing apparatus according to the present invention includes a processor, in which the processor is configured to acquire first image data obtained by imaging a space, determine a position of a virtual projection apparatus in the space, acquire a plurality of projection points that are intersections between a plurality of projection rays of the virtual projection apparatus and an object in the space, and determine a position and a shape of a virtual projection surface based on the plurality of projection points, generate second image data representing a second image in which the virtual projection surface is displayed on a first image represented by the first image data, and output the second image data to an output destination.

An information processing apparatus according to the present invention includes a processor, in which the processor is configured to determine a position of a virtual projection apparatus in a space, acquire a plurality of projection points that are intersections between a plurality of projection rays of the virtual projection apparatus and an object in the space, and determine a position and a shape of a virtual projection surface based on the plurality of projection points, generate image data representing the virtual projection surface, and output the image data to a display destination.

An information processing method according to the present invention, executed by a processor of an information processing apparatus, the method including: acquiring first image data obtained by imaging a space; determining a position of a virtual projection apparatus in the space; acquiring a plurality of projection points that are intersections between a plurality of projection rays of the virtual projection apparatus and an object in the space; and determining a position and a shape of a virtual projection surface based on the plurality of projection points; generating second image data representing a second image in which the virtual projection surface is displayed on a first image represented by the first image data; and outputting the second image data to an output destination.

A non-transitory computer-readable storage medium storing an information processing program according to the present invention, causing a processor of an information processing apparatus to execute a process including: acquiring first image data obtained by imaging a space; determining a position of a virtual projection apparatus in the space; acquiring a plurality of projection points that are intersections between a plurality of projection rays of the virtual projection apparatus and an object in the space, and determining a position and a shape of a virtual projection surface based on the plurality of projection points; generating second image data representing a second image in which the virtual projection surface is displayed on a first image represented by the first image data; and outputting the second image data to an output destination.

According to the present invention, it is possible to provide an information processing apparatus, an information processing method, and an information processing program that can more accurately simulate a projection state of a projection apparatus.

### BRIEF DESCRIPTION OF THE DRAWINGS

FIG. 1 is a schematic diagram showing an example of a projection apparatus 10 that is a target for installation support by an information processing apparatus according to an embodiment.

FIG. 2 is a schematic diagram showing an example of an internal configuration of a projection section 1 shown in FIG. 1.

FIG. 3 is a schematic diagram showing an external configuration of the projection apparatus 10.

FIG. 4 is a schematic cross-sectional diagram of an optical unit 106 of the projection apparatus 10 shown in FIG. 3.

FIG. 5 is a diagram showing an example of an information processing apparatus 50 according to the embodiment.

FIG. 6 is a diagram showing an example of a hardware configuration of the information processing apparatus 50.

FIG. 7 is a diagram showing an example of generation of a virtual projection surface.

FIG. 8 is a diagram showing an example of the generated virtual projection surface.

FIG. 9 is a diagram showing an example of the virtual projection surface generated by increasing the number of the projection points.

FIG. 10 is a diagram showing an example of a virtual projection surface 77 generated by using a virtual target object as a projection target object.

FIG. 11 is a diagram showing an example of a case where a projection point 75 cannot be acquired for projection rays 73 of a virtual projection apparatus 72.

FIG. 12 is a diagram showing a generation example (first generation example) of the virtual projection surface in a case where the projection point 75 of the projection rays 73 cannot be acquired.

FIG. 13 is a diagram showing a generation example (second generation example) of the virtual projection surface in a case where the projection point 75 of the projection rays 73 cannot be acquired.

FIG. 14 is a diagram showing an example (first grouping) of grouping the acquired plurality of projection points 75.

FIG. 15 is a diagram showing an example (second grouping) of grouping the acquired plurality of projection points 75.

FIG. 16 is a diagram showing a case where the projection rays 73 of the virtual projection apparatus 72 are projected onto the virtual projection apparatus 72 itself.

FIG. 17 is a diagram showing an example of viewing an image of the virtual projection apparatus 72 from a viewpoint of an assumed viewer.

FIG. 18 is a diagram showing an example of correction data 86 for making the image viewed from the viewpoint of the assumed viewer have a specific shape.

FIG. 19 is a diagram showing a corrected projection surface 177 corrected by the correction data.

FIG. 20 is a diagram showing an example of changing a position of the recognized projection point 75.

FIG. 21 is a diagram showing an example of display of the virtual projection surface using a transmissive AR glass.

FIG. 22 is a diagram showing a display example of a lens shift range of the virtual projection apparatus 72.

### DESCRIPTION OF THE PREFERRED EMBODIMENTS

Hereinafter, an example of an embodiment of the present invention will be described with reference to the drawings.

### <Projection Apparatus 10 of Target for Installation Support by Information Processing Apparatus According to Embodiment>

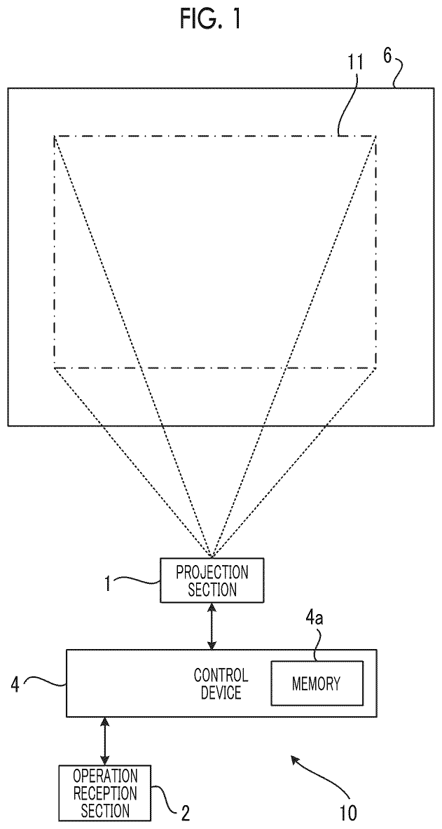

FIG. 1 is a schematic diagram showing an example of a projection apparatus 10 that is a target for installation support by an information processing apparatus according to an embodiment.

The information processing apparatus according to the embodiment can be used, for example, to support installation of the projection apparatus 10. The projection apparatus 10 comprises a projection section 1, a control device 4, and an operation reception section 2. The projection section 1 is composed of, for example, a liquid crystal projector or a projector using liquid crystal on silicon (LCOS). Hereinafter, the projection section 1 will be described as a liquid crystal projector.

The control device 4 is a control device that controls projection performed by the projection apparatus 10. The control device 4 is a device including a control unit composed of various processors, a communication interface (not shown) for communicating with each portion, and a memory 4a such as a hard disk, a solid-state drive (SSD), or a read-only memory (ROM) and integrally controls the projection section 1.

Examples of the various processors of the control portion of the control device 4 include a central processing unit (CPU) that is a general-purpose processor performing various types of processing by executing a program, a programmable logic device (PLD) such as a field programmable gate array (FPGA) that is a processor having a circuit configuration changeable after manufacture, or a dedicated electric circuit such as an application specific integrated circuit (ASIC) that is a processor having a circuit configuration dedicatedly designed to execute specific processing.

More specifically, a structure of these various processors is an electric circuit in which circuit elements such as semiconductor elements are combined. The control portion of the control device 4 may be configured with one of the various processors or may be configured with a combination of two or more processors of the same type or different types (for example, a combination of a plurality of FPGAs or a combination of a CPU and a FPGA).

The operation reception section 2 detects an instruction from a user by receiving various operations from the user. The operation reception section 2 may be a button, a key, a joystick, or the like provided in the control device 4 or may be a reception portion or the like that receives a signal from a remote controller for remotely operating the control device 4.

A projection object 6 is an object such as a screen or a wall having a projection surface on which a projection image is displayed by the projection section 1. In the example shown in FIG. 1, in the projection object 6, the projection surface of the projection object 6 is a rectangular plane. It is assumed that upper, lower, left, and right sides of the projection object 6 in FIG. 1 are upper, lower, left, and right sides of the actual projection object 6.

A projection range 11 shown by a dot-dashed line is a region irradiated with projection light by the projection section 1 in the projection object 6. In the example shown in FIG. 1, the projection range 11 is rectangular. The projection range 11 is a part or the entirety of a projectable range in which the projection can be performed by the projection section 1.

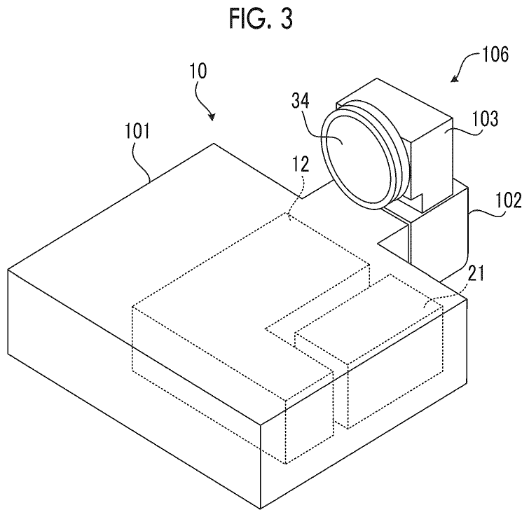

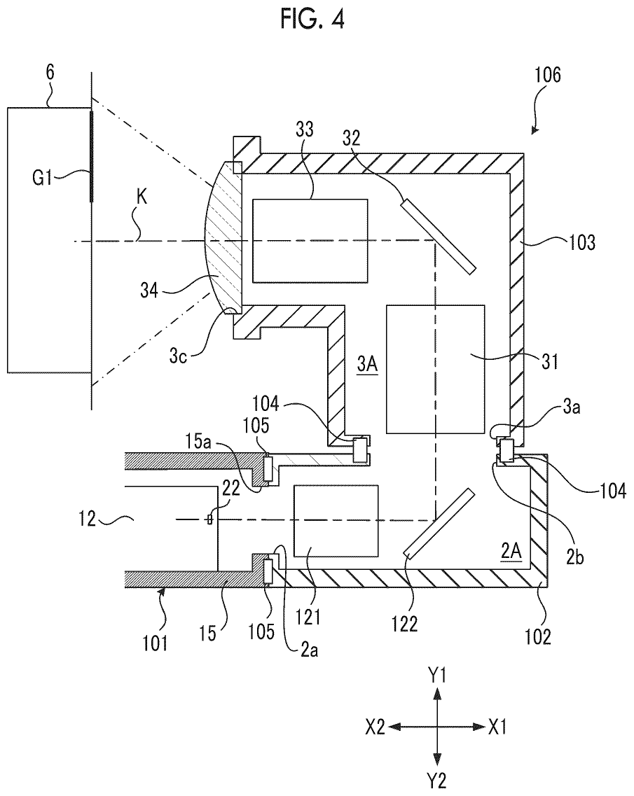

The projection section 1, the control device 4, and the operation reception section 2 are implemented by, for example, a single device (for example, see FIGS. 3 and 4). Alternatively, the projection section 1, the control device 4, and the operation reception section 2 may be separate devices that cooperate by communicating with each other.

### <Internal Configuration of Projection Section 1 Shown in FIG. 1>

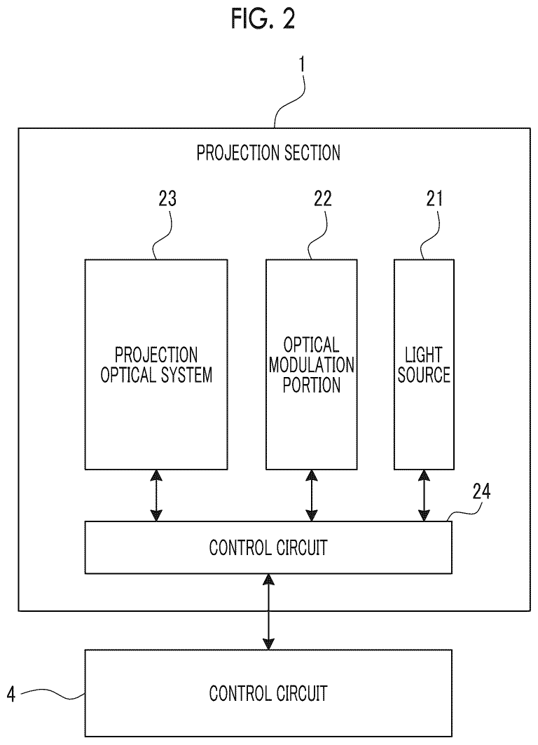

FIG. 2 is a schematic diagram showing an example of an internal configuration of the projection section 1 shown in FIG. 1.

As shown in FIG. 2, the projection section 1 comprises a light source 21, an optical modulation portion 22, a projection optical system 23, and a control circuit 24.

The light source 21 includes a light emitting element such as a laser or a light emitting diode (LED) and emits, for example, white light.

The optical modulation portion 22 is composed of three liquid crystal panels that emit each color image by modulating, based on image information, each color light beam which is emitted from the light source 21 and is separated into three colors of red, blue, and green by a color separation mechanism (not shown). Filters of red, blue, and green may be mounted in the three liquid crystal panels, respectively, and the images of each color may be emitted by modulating the white light emitted from the light source 21 in each liquid crystal panel.

The light from the light source 21 and the optical modulation portion 22 is incident on the projection optical system 23. The projection optical system 23 includes at least one lens and is composed of, for example, a relay optical system. The light that has passed through the projection optical system 23 is projected onto the projection object 6.

In the projection object 6, a region irradiated with the light transmitted through the entire range of the optical modulation portion 22 is the projectable range in which the projection can be performed by the projection section 1. Within this projectable range, a region irradiated with the light actually transmitted from the optical modulation portion 22 is the projection range 11. For example, in the projectable range, a size, a position, and a shape of the projection range 11 are changed by controlling a size, a position, and a shape of a region through which the light is transmitted in the optical modulation portion 22.

The control circuit 24 projects an image based on display data to the projection object 6 by controlling the light source 21, the optical modulation portion 22, and the projection optical system 23 based on the display data input from the control device 4. The display data input into the control circuit 24 is composed of three pieces of data including red display data, blue display data, and green display data.

In addition, the control circuit 24 changes the projection optical system 23 based on an instruction input from the control device 4, thereby enlarging or reducing the projection range 11 (see FIG. 1) of the projection section 1. In addition, the control device 4 may move the projection range 11 of the projection section 1 by changing the projection optical system 23 based on the operation received by the operation reception section 2 from the user.

In addition, the projection apparatus 10 comprises a shift mechanism that mechanically or optically moves the projection range 11 while maintaining an image circle of the projection optical system 23. The image circle of the projection optical system 23 is a region in which the projection light incident on the projection optical system 23 appropriately passes through the projection optical system 23 in terms of a light fall-off, color separation, edge part curvature, or the like.

The shift mechanism is implemented by at least one of an optical system shift mechanism that performs optical system shifting, or an electronic shift mechanism that performs electronic shifting.

The optical system shift mechanism is, for example, a mechanism (for example, see FIGS. 3 and 4) that moves the projection optical system 23 in a direction perpendicular to an optical axis or a mechanism that moves the optical modulation portion 22 in the direction perpendicular to the optical axis instead of moving the projection optical system 23. In addition, the optical system shift mechanism may perform the movement of the projection optical system 23 and the movement of the optical modulation portion 22 in combination with each other.

The electronic shift mechanism is a mechanism that performs pseudo shifting of the projection range 11 by changing a range through which the light is transmitted in the optical modulation portion 22.

In addition, the projection apparatus 10 may comprise a projection direction changing mechanism that moves the image circle of the projection optical system 23 and the projection range 11. The projection direction changing mechanism is a mechanism that changes a projection direction of the projection section 1 by changing the orientation of the projection section 1 through mechanical rotation (for example, see FIGS. 3 and 4).

### <Mechanical Configuration of Projection Apparatus 10>

FIG. 3 is a schematic diagram showing an external configuration of the projection apparatus 10. FIG. 4 is a schematic cross-sectional diagram of an optical unit 106 of the projection apparatus 10 shown in FIG. 3. FIG. 4 shows a cross section in a plane along an optical path of light emitted from a body part 101 shown in FIG. 3.

As shown in FIG. 3, the projection apparatus 10 comprises the body part 101 and the optical unit 106 that is provided to protrude from the body part 101. In the configuration shown in FIG. 3, the operation reception section 2, the control device 4, and the light source 21, the optical modulation portion 22, and the control circuit 24 in the projection section 1 are provided in the body part 101. The projection optical system 23 in the projection section 1 is provided in the optical unit 106.

The optical unit 106 comprises a first member 102 supported by the body part 101 and a second member 103 supported by the first member 102.

The first member 102 and the second member 103 may be an integrated member. The optical unit 106 may be configured to be attachable to and detachable from the body part 101 (in other words, configured to be interchangeable).

The body part 101 includes a housing 15 (see FIG. 4) in which an opening 15a (see FIG. 4) for passing light is formed in a part connected to the optical unit 106.

As shown in FIG. 3, the light source 21 and an optical modulation unit 12 including the optical modulation portion 22 (see FIG. 2) that generates an image by spatially modulating the light emitted from the light source 21 based on input image data are provided inside the housing 15 of the body part 101.

The light emitted from the light source 21 is incident on the optical modulation portion 22 of the optical modulation unit 12 and is spatially modulated and emitted by the optical modulation portion 22.

As shown in FIG. 4, the image formed by the light spatially modulated by the optical modulation unit 12 is incident on the optical unit 106 by passing through the opening 15a of the housing 15 and is projected onto the projection object 6 as a projection target object. Accordingly, an image G1 is visible from an observer.

The optical unit 106, as shown in FIG. 4, comprises the first member 102 including a hollow portion 2A connected to the inside of the body part 101, the second member 103 including a hollow portion 3A connected to the hollow portion 2A, a first optical system 121 and a reflective member 122 disposed in the hollow portion 2A, a second optical system 31, a reflective member 32, a third optical system 33, and a lens 34 disposed in the hollow portion 3A, a shift mechanism 105, and a projection direction changing mechanism 104.

The first member 102 is a member having, for example, a rectangular cross-sectional outer shape, in which an opening 2a and an opening 2b are formed in surfaces perpendicular to each other. The first member 102 is supported by the body part 101 in a state in which the opening 2a is disposed at a position facing the opening 15a of the body part 101. The light emitted from the optical modulation portion 22 of the optical modulation unit 12 of the body part 101 is incident into the hollow portion 2A of the first member 102 through the opening 15a and the opening 2a.

An incidence direction of the light incident into the hollow portion 2A from the body part 101 will be referred to as a direction X1. A direction opposite to the direction X1 will be referred to as a direction X2. The direction X1 and the direction X2 will be collectively referred to as a direction X. In FIG. 4, the direction from the front to the back of the page and the opposite direction thereto will be referred to as a direction Z. In the direction Z, the direction from the front to the back of the page will be referred to as a direction Z1, and the direction from the back to the front of the page will be referred to as a direction Z2.

In addition, a direction perpendicular to the direction X and to the direction Z will be referred to as a direction Y. In the direction Y, an upward direction in FIG. 4 will be referred to as a direction Y1, and a downward direction in FIG. 4 will be referred to as a direction Y2. In the example in FIG. 4, the projection apparatus 10 is disposed such that the direction Y2 is a vertical direction.

The projection optical system 23 shown in FIG. 2 is composed of the first optical system 121, the reflective member 122, the second optical system 31, the reflective member 32, the third optical system 33, and the lens 34. An optical axis K of the projection optical system 23 is shown in FIG. 4. The first optical system 121, the reflective member 122, the second optical system 31, the reflective member 32, the third optical system 33, and the lens 34 are disposed in this order from the optical modulation portion 22 side along the optical axis K.

The first optical system 121 includes at least one lens and guides the light that is incident on the first member 102 from the body part 101 and travels in the direction X1 to the reflective member 122.

The reflective member 122 reflects the light incident from the first optical system 121 in the direction Y1. The reflective member 122 is composed of, for example, a mirror. In the first member 102, the opening 2b is formed on an optical path of the light reflected by the reflective member 122, and the reflected light travels to the hollow portion 3A of the second member 103 by passing through the opening 2b.

The second member 103 is a member having an approximately T-shaped cross-sectional outer shape, in which an opening 3a is formed at a position facing the opening 2b of the first member 102. The light that has passed through the opening 2b of the first member 102 from the body part 101 is incident into the hollow portion 3A of the second member 103 through the opening 3a. The first member 102 and the second member 103 may have any cross-sectional exterior and are not limited to the above.

The second optical system 31 includes at least one lens and guides the light incident from the first member 102 to the reflective member 32.

The reflective member 32 guides the light incident from the second optical system 31 to the third optical system 33 by reflecting the light in the direction X2. The reflective member 32 is composed of, for example, a mirror.

The third optical system 33 includes at least one lens and guides the light reflected by the reflective member 32 to the lens 34.

The lens 34 closes an opening 3c formed in an end part of the second member 103 on a direction X2 side and is disposed in the end part. The lens 34 projects the light incident from the third optical system 33 onto the projection object 6.

The projection direction changing mechanism 104 is a rotation mechanism that rotatably connects the second member 103 to the first member 102. By the projection direction changing mechanism 104, the second member 103 is configured to be rotatable about a rotation axis (specifically, the optical axis K) that extends in the direction Y. The projection direction changing mechanism 104 is not limited to the disposition position shown in FIG. 4 as long as the projection direction changing mechanism 104 can rotate the optical system. In addition, the number of rotation mechanisms is not limited to one, and a plurality of rotation mechanisms may be provided.

The shift mechanism 105 is a mechanism for moving the optical axis K of the projection optical system (in other words, the optical unit 106) in a direction (direction Y in FIG. 4) perpendicular to the optical axis K. Specifically, the shift mechanism 105 is configured to be able to change a position of the first member 102 in the direction Y with respect to the body part 101. The shift mechanism 105 may manually move the first member 102 or electrically move the first member 102.

FIG. 4 shows a state in which the first member 102 is moved as far as possible to the direction Y1 side by the shift mechanism 105. By moving the first member 102 in the direction Y2 by the shift mechanism 105 from the state shown in FIG. 4, the relative position between the center of the image (in other words, the center of the display surface) formed by the optical modulation portion 22 and the optical axis K changes, and the image G1 projected onto the projection object 6 can be shifted (translated) in the direction Y2.

The shift mechanism 105 may be a mechanism that moves the optical modulation portion 22 in the direction Y instead of moving the optical unit 106 in the direction Y. Even in this case, the image G1 projected onto the projection object 6 can be moved in the direction Y2.

### <Information Processing Apparatus 50 According to Embodiment>

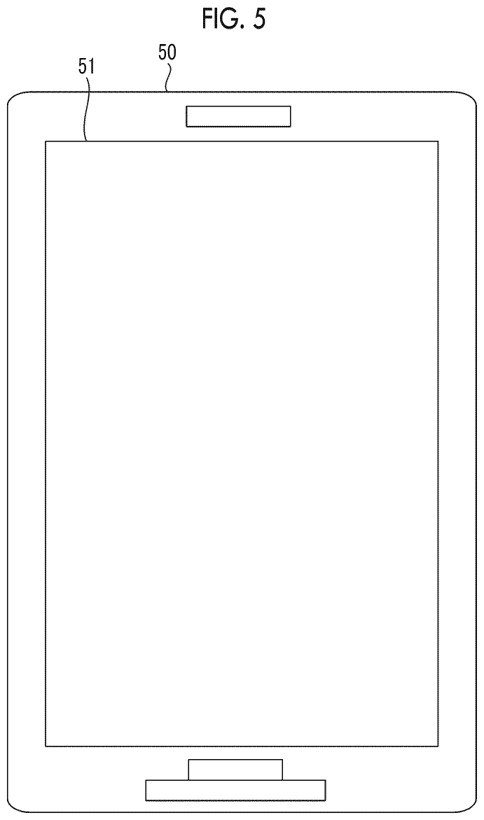

FIG. 5 is a diagram showing an example of the information processing apparatus 50 according to the embodiment. The information processing apparatus 50 according to the embodiment is a tablet terminal and the like having a touch panel 51. The touch panel 51 is a display that allows a touch operation. For example, in a case where projection is performed using the projection apparatus 10 in a space such as a room, the information processing apparatus 50 is used to find an appropriate installation position of the projection apparatus 10 and the projection object 6 to which light is projected from the projection apparatus 10. A user of the information processing apparatus 50 brings the information processing apparatus 50 into a space (room) in which the projection is performed by the projection apparatus 10. The information processing apparatus 50 displays an installation support image for supporting installation of the projection apparatus 10 and the projection object 6 in the space on the touch panel 51.

For example, the information processing apparatus 50 displays, as an installation support image, a second image in which an image of a virtual projection surface, which is a virtually-defined projection surface, and an image of a virtual projection apparatus, which is a virtually-defined projection apparatus, are superimposed on a first image obtained by imaging the space in which the projection apparatus 10 is installed and performs the projection. The user of the information processing apparatus 50 can acquire information related to the installation of the projection apparatus 10 and the projection object 6 while referring to the installation support image.

### <Hardware Configuration of Information Processing Apparatus 50>

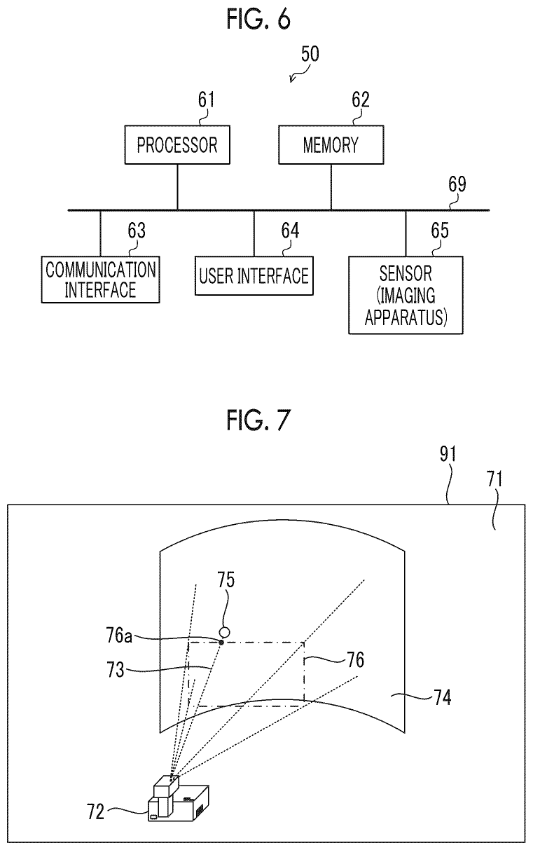

FIG. 6 is a diagram showing an example of a hardware configuration of the information processing apparatus 50. For example, as shown in FIG. 6, the information processing apparatus 50 shown in FIG. 5 comprises a processor 61, a memory 62, a communication interface 63, a user interface 64, and a sensor 65. The processor 61, the memory 62, the communication interface 63, the user interface 64, and the sensor 65 are connected by, for example, a bus 69.

The processor 61 is a circuit that performs signal processing, and is, for example, a CPU that controls the entire information processing apparatus 50. The processor 61 may be implemented by other digital circuits such as an FPGA and a digital signal processor (DSP). The processor 61 may also be implemented by combining a plurality of digital circuits.

For example, the memory 62 includes a main memory and an auxiliary memory. For example, the main memory is a random-access memory (RAM). The main memory is used as a work area of the processor 61.

The auxiliary memory is, for example, a non-volatile memory such as a magnetic disk or a flash memory. The auxiliary memory stores various programs for operating the information processing apparatus 50. The programs stored in the auxiliary memory are loaded into the main memory and executed by the processor 61.

In addition, the auxiliary memory may include a portable memory that can be detached from the information processing apparatus 50. Examples of the portable memory include a universal serial bus (USB) flash drive, a memory card such as a secure digital (SD) memory card, and an external hard disk drive.

The communication interface 63 is a communication interface for communicating with apparatuses outside the information processing apparatus 50. The communication interface 63 includes at least any of a wired communication interface for performing wired communication or a wireless communication interface for performing wireless communication. The communication interface 63 is controlled by the processor 61.

The user interface 64 includes, for example, an input device that receives an operation input from the user, and an output device that outputs information to the user. The input device can be implemented by, for example, a key (for example, a keyboard) or a remote controller. The output device can be implemented by, for example, a display or a speaker. In the information processing apparatus 50 shown in FIG. 5, the input device and the output device are implemented by the touch panel 51. The user interface 64 is controlled by the processor 61. The information processing apparatus 50 receives various types of designation from the user using the user interface 64.

The sensor 65 includes an imaging apparatus that includes an imaging optical system and an imaging element and that can perform imaging, a space recognition sensor that can three-dimensionally recognize a space around the information processing apparatus 50, and the like. For example, the imaging apparatus includes an imaging apparatus provided on a rear surface of the information processing apparatus 50 shown in FIG. 5.

The space recognition sensor is, as an example, a light detection and ranging (LiDAR) sensor of performing irradiation with laser light, measuring a time taken until the laser light of irradiation hits an object and reflects back, and measuring a distance and a direction to the object. However, the space recognition sensor is not limited thereto and can be various sensors such as a radar that emits radio waves, and an ultrasonic sensor that emits ultrasound waves.

### <First Aspect of Processing of Information Processing Apparatus 50>

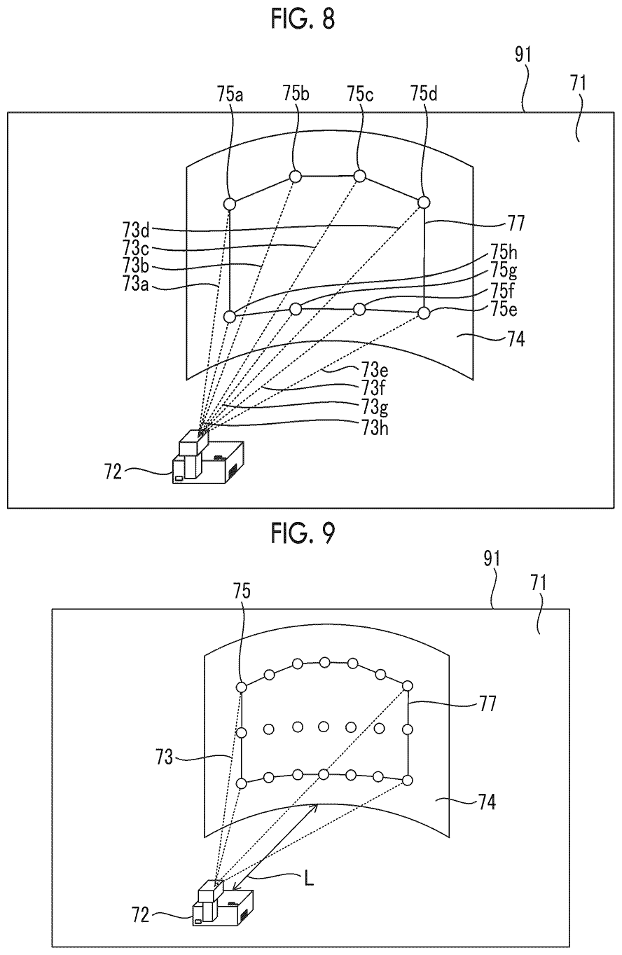

A first aspect of processing of the information processing apparatus 50 will be described with reference to FIGS. 7 and 8. FIG. 7 is a diagram showing an example of generation of the virtual projection surface. FIG. 8 is a diagram showing an example of the generated virtual projection surface.

In a case of generating the virtual projection surface, the processor 61 of the information processing apparatus 50 acquires space image data representing a space image 71 of a physical space in which the projection apparatus 10 is installed and projection is performed by the projection apparatus 10. The “space image 71” may be, for example, a captured image of a space imaged by an imaging apparatus, or may be an image generated from a three-dimensional (3D) model of a space or the like.

The imaging apparatus that images the space may be an imaging apparatus that is provided integrally with the information processing apparatus 50 or may be an external imaging apparatus. The space image data is, for example, imaging data of a space obtained by imaging with an imaging apparatus or data of an image generated from a 3D model. The space image 71 is an example of a “first image” in the present invention. The space image data is an example of “first image data” in the present invention.

As shown in FIG. 7, the processor 61 determines a position of a virtual projection apparatus 72 that is a virtual projection apparatus in the space. In addition, the processor 61 acquires a projection point 75 that is an intersection between projection rays 73 projected from the virtual projection apparatus 72 and a projection target object 74 in the space. The position of the virtual projection apparatus 72 may be determined based on an instruction from the user of the information processing apparatus 50 or may be determined based on analysis processing of the space image 71.

The projection rays 73 projected from the virtual projection apparatus 72 are, for example, linear light that passes through any one point on a rectangular virtual reference projection surface 76 generated as viewed from the virtual projection apparatus 72. The projection point 75 shown in FIG. 7 is a point at which the projection rays 73 from the virtual projection apparatus 72 pass through one point 76a on the virtual reference projection surface 76 and intersect the projection target object 74. The projection target object 74 may be an object present in the space that is detected by space recognition or may be a virtual target object. The projection target object 74 of the present example is a wall surface of a room formed in a curved shape. The projection target object 74 is an example of an “object” in the present invention.

As shown in FIG. 8, the processor 61 acquires a plurality of projection points 75 (in the present example, projection points 75a to 75h) that are intersections between a plurality of projection rays 73 (in the present example, projection rays 73a to 73h) projected from the virtual projection apparatus 72 and the projection target object 74. The processor 61 determines a position and a shape of a virtual projection surface 77 based on the acquired plurality of projection points 75a to 75h. The plurality of projection points are the number of projection points required to determine the virtual projection surface 77, and are, for example, four or more projection points. The determination of the position and the shape of the virtual projection surface 77 is to determine the position and the shape of the virtual projection surface 77 by, for example, processing the plurality of projection points 75a to 75h as a polygon or by performing an approximation process using a polynomial surface.

The processor 61 can execute planar determination processing of determining the position and the shape of the virtual projection surface by assuming that the projection target surface of the projection target object 74 is planar and non-planar determination processing of determining the position and the shape of the virtual projection surface by assuming that the projection target surface of the projection target object 74 is non-planar. In the non-planar determination processing among these processes, the processor 61 determines the position and the shape of the virtual projection surface 77 based on the plurality of projection points 75. The planar determination processing is an example of “first processing” in the present invention. The non-planar determination processing is an example of “second processing” in the present invention.

The processor 61 generates a virtual projection image 91 based on the virtual projection apparatus 72 and the virtual projection surface 77. The virtual projection image 91 is an image in which the virtual projection apparatus 72 and the virtual projection surface 77 are displayed on the space image 71 represented by the space image data. For example, the virtual projection image 91 is an image in which the virtual projection apparatus 72 and the virtual projection surface 77 are superimposed on the space image 71 represented by the space image data. The virtual projection image 91 is an example of a “second image” in the present invention.

The processor 61 acquires virtual projection image data representing the virtual projection image 91. The processor 61 outputs the acquired virtual projection image data to a predetermined output destination. The output destination of the virtual projection image data may be, for example, a display unit (touch panel 51) provided in the information processing apparatus 50 or a display device provided outside. As a result, the virtual projection image 91 represented by the virtual projection image data can be displayed. The virtual projection image data is an example of “second image data” in the present invention.

As described above, the information processing apparatus 50 of the first aspect displays the virtual projection image 91 in which the virtual projection surface 77 determined by the plurality of projection points 75 is displayed on the space image 71 in which the projection is performed by the projection apparatus 10, and outputs the virtual projection image 91 to the touch panel 51 of the information processing apparatus 50. According to this configuration, in a case where a user who performs projection by the virtual projection apparatus 72 installs the virtual projection apparatus 72 at a position in an installation space, it is possible to easily and more accurately simulate a shape in which the virtual projection surface 77 of the virtual projection apparatus 72 is projected onto the projection target object 74.

The processor 61 determines the position and the shape of the virtual projection surface 77 based on, for example, the space image data representing the space image 71 in which the virtual projection apparatus 72 and the virtual projection surface 77 are superimposed, but may determine the position and the shape of the virtual projection surface 77 based on other space image data (for example, space image data captured at another timing or space image data captured by another imaging device).

### <Second Aspect of Processing of Information Processing Apparatus 50>

A second aspect of processing of the information processing apparatus 50 will be described with reference to FIG. 9. FIG. 9 is a diagram showing an example of the virtual projection surface generated by increasing the number of the projection points.

In a case of determining the virtual projection surface 77, the processor 61 determines the number of projection points 75 to be acquired based on a distance L between the virtual projection apparatus 72 and the projection target object 74. The distance between the virtual projection apparatus 72 and the projection target object 74 may be, for example, a distance on an optical axis of the virtual projection apparatus 72 or a representative value (for example, an average value, a mode value, a minimum value, a maximum value, or the like) of distances on the plurality of projection rays 73. The determination of the number of projection points 75 based on the distance L is to increase the number of projection points 75 in order to obtain the virtual projection surface 77 having an accurate shape because the larger the distance L is, the larger the size of the determined virtual projection surface 77 is. In the present example, the virtual projection surface 77 is determined by using 21 projection points 75 acquired in 3 in the vertical direction and 7 in the horizontal direction.

In addition, in a case of determining the virtual projection surface 77, the processor 61 may determine the number of projection points 75 to be acquired based on a recognition result of the space. The determination of the number of projection points 75 based on the recognition result of the space is, for example, to increase the number of projection points 75 to be acquired as the undulation of the recognized space is larger (as the space is more complex). In addition, in the determination of the number of projection points 75, the number of projection points 75 may be increased as the undulation of the space is larger, or the number of projection points 75 may be determined by considering the number and the magnitude of the undulations in combination. In addition, in the determination of the number of projection points 75, the virtual projection surface 77 may be first determined by an appropriate number of projection points 75, and an appropriate number of projection points 75 may be determined based on a degree of match between the determined virtual projection surface 77 and the recognized space. The space to be recognized may be limited to, for example, a region in a projection direction in which the virtual projection apparatus 72 projects the projection rays 73.

The actual projection apparatus 10 emits an infinite number of projection rays 73. In a case where the number of projection points 75 used in the simulation is increased, the shape of the virtual projection surface 77 approaches the projection surface of the actual projection apparatus 10, but the processing amount of the processor 61 increases, which leads to a decrease in the display frame rate or the response to the operation and an increase in the battery consumption. On the other hand, according to the information processing apparatus 50 of the second aspect, the number of projection points 75 for determining the virtual projection surface 77 can be changed according to the distance L between the virtual projection apparatus 72 and the projection target object 74 or the complexity of the space to be recognized. Therefore, it is possible to improve the reproducibility of the shape of the projection surface while maintaining the responsiveness of the processor 61.

In addition, in a case of determining the virtual projection surface 77, the projection apparatus 10 may determine the number of projection points 75 to be acquired in response to an operation from the user. That is, in a case where the user performs an operation of changing the position of the virtual projection apparatus 72 or the virtual projection surface 77 or changing the aspect ratio of the virtual projection surface 77 or the like, that is, an operation in which the shape calculation of the virtual projection surface 77 is required again, the projection apparatus 10 may temporarily change the number of projection points 75 to be acquired. For example, the projection apparatus 10 deletes the projection points other than a portion that hits an outer frame of the projection surface, and determines the number of projection points 75 for understanding the general shape of the virtual projection surface 77. In a case where it is considered that the user has finished the operation related to the movement, for example, in a case where a predetermined time has elapsed since the position of the virtual projection apparatus 72 or the virtual projection surface 77 is last changed, the shape of the virtual projection surface 77 is obtained again by the number of projection points 75 returned to the original number.

In a case where the space structure is complex, the number of projection points 75 needs to be increased in order to reproduce the shape of the projection surface. On the other hand, in a case where all the projection points 75 are obtained again each time the user slightly changes the position of the virtual projection apparatus 72 or the virtual projection surface 77, a delay until the result is reflected in the user operation increases. On the other hand, as described above, in a case where the user continuously performs the operation, the number of projection points 75 is temporarily reduced to a level at which the general shape of the virtual projection surface 77 can be understood, so that the user can perform the operation comfortably while roughly grasping the change in the virtual projection surface 77 due to the operation.

In addition, in a case of determining the virtual projection surface 77, the projection apparatus 10 may determine the number of projection points 75 to be acquired in response to an operation from the user who issues an instruction to the number of projection points 75. The operation from the user who issues the instruction to the number of projection points 75 may be an operation of directly issuing the instruction to the number of projection points 75 or an operation of increasing or decreasing the current number of projection points 75.

### <Third Aspect of Processing of Information Processing Apparatus 50>

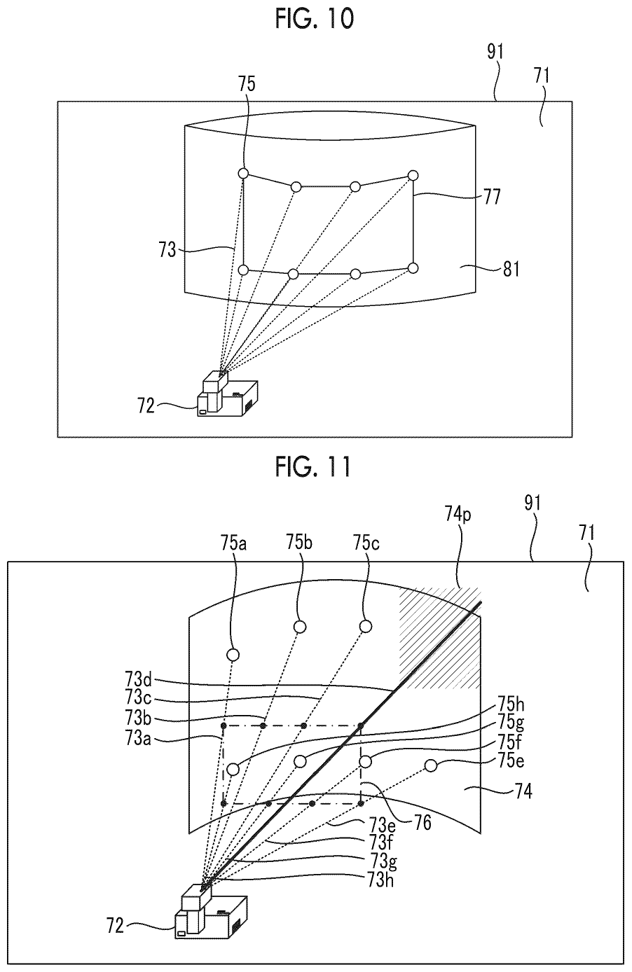

A third aspect of processing of the information processing apparatus 50 will be described with reference to FIG. 10. FIG. 10 is a diagram showing an example of the virtual projection surface 77 generated by using a virtual target object as the projection target object.

As shown in FIG. 10, the processor 61 acquires a plurality (eight in the present example) of projection points 75 that are intersections between a plurality (eight in the present example) of projection rays 73 projected from the virtual projection apparatus 72 and a virtual projection target object 81, and determines the virtual projection surface 77 based on the acquired projection points 75. The virtual projection target object 81 is a virtual target object that is disposed as being present in a virtual space representing the space of the projection apparatus 10. The virtual projection target object 81 is, for example, a target object that can be disposed based on an instruction (operation) from the user of the information processing apparatus 50. The virtual projection target object 81 of the present example is, for example, a movable installation having a cylindrical shape. The virtual projection target object 81 is an example of an “object” in the present invention.

According to the information processing apparatus 50 of the third aspect, since the virtual projection target object 81 can be regarded as the structure of the space, the projection target object before the construction can be virtually installed in the space, and the projection simulation can be performed by assuming the space in accordance with the intention of the user.

### <Fourth Aspect of Processing of Information Processing Apparatus 50>

A fourth aspect of processing of the information processing apparatus 50 will be described with reference to FIG. 11. FIG. 11 is a diagram showing an example of a case where the projection point 75 cannot be acquired for the projection rays 73 of the virtual projection apparatus 72.

The information processing apparatus 50 can recognize a structure of the space by, for example, an imaging device mounted on the information processing apparatus 50, but there is a limit to the range that can be recognized. Therefore, although a structure that intersects the projection rays 73 from the virtual projection apparatus 72 actually exists, the projection point 75 may not be obtained because the structure is outside the recognition range of the imaging device.

For example, as shown in FIG. 11, in a case of attempting to acquire the intersection between the plurality of projection rays 73a to 73h projected from the virtual projection apparatus 72 and the projection target object 74, it is assumed that the imaging device of the information processing apparatus 50 cannot recognize a partial region 74p of the projection target object 74. In this case, the projection points 75a to 75c and 75e to 75h that are the intersections between the projection rays 73a to 73c and 73e to 73h and the projection target object 74 can be acquired, but the projection point of the projection ray 73d intersecting the region 74p of the projection target object 74 cannot be acquired.

Therefore, in a case where the processor 61 of the information processing apparatus 50 recognizes that there is the projection ray 73 for which the projection point 75 cannot be acquired among the plurality of projection rays 73, the processor 61 notifies the user of the recognition result. For example, as shown in FIG. 11, the processor 61 displays a route of the projection ray 73d for which the projection point cannot be acquired, with a thicker line than the other projection rays 73a to 73c and 73e to 73h.

According to the information processing apparatus 50 of the fourth aspect, by notifying the user that the projection point 75 cannot be acquired, it is possible to prompt the user to respond, for example, to change the installation position of the virtual projection apparatus 72, to move the position of the information processing apparatus 50 to recognize the space structure, or to increase the number of projection points 75 for determining the virtual projection surface 77. As a result, it is possible to acquire the projection point 75 of the region that cannot be acquired.

### <Fifth Aspect of Processing of Information Processing Apparatus 50>

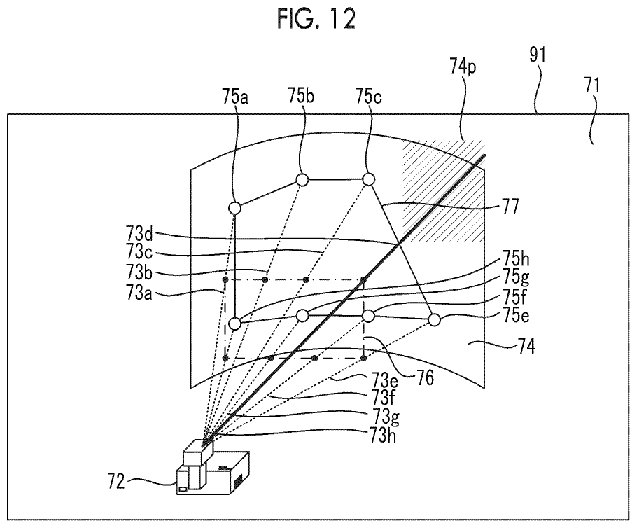

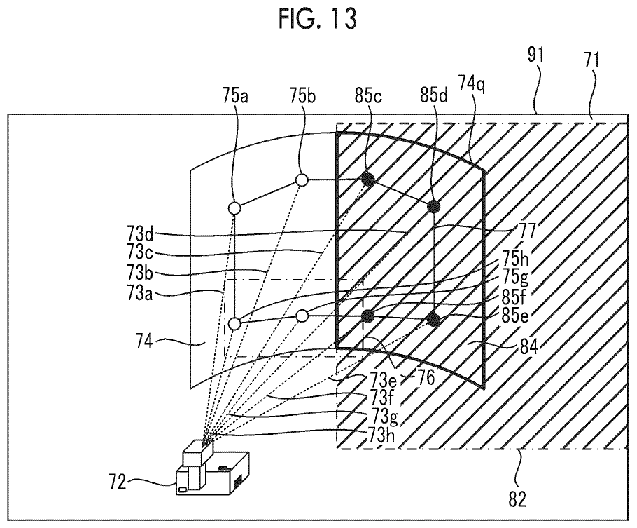

A fifth aspect of processing of the information processing apparatus 50 will be described with reference to FIGS. 12 and 13. FIG. 12 is a diagram showing a generation example (first generation example) of the virtual projection surface in a case where the projection point 75 of the projection rays 73 cannot be acquired. FIG. 13 is a diagram showing a generation example (second generation example) of the virtual projection surface in a case where the projection point 75 of the projection rays 73 cannot be acquired.

### First Generation Example

For example, as shown in FIG. 12, in a case of attempting to acquire the intersection between the projection rays 73a to 73h of the virtual projection apparatus 72 and the projection target object 74, it is assumed that the information processing apparatus 50 cannot recognize a partial region 74p of the projection target object 74. In this case, the projection points 75a to 75c and 75e to 75h that are the intersections between the projection rays 73a to 73c and 73e to 73h and the projection target object 74 can be acquired, but the projection point of the projection ray 73d intersecting the region 74p of the projection target object 74 cannot be acquired. This state is the same as the state described in FIG. 11.

Therefore, in a case where there is the projection ray 73 for which the projection point 75 cannot be acquired among the plurality of projection rays 73, the processor 61 of the information processing apparatus 50 determines the position and the shape of the virtual projection surface 77 based on the projection points 75 that can be acquired, excluding the projection point 75 related to the projection ray 73 that cannot be acquired. Specifically, as shown in FIG. 12, the processor 61 determines the position and the shape of the virtual projection surface 77 based on the projection points 75a to 75c and 75e to 75h of the projection rays 73a to 73c and 73e to 73h for which the projection points can be acquired, without considering the projection point of the projection ray 73d for which the projection point cannot be acquired.

In a case where there is the projection point 75 that cannot be acquired, the virtual projection surface 77 is created by excluding the projection point 75 that cannot be acquired, so that it is possible to display the virtual projection surface 77 having a shape close to the actual projection even in a space in which the structure is difficult to recognize.

### Second Generation Example

For example, as shown in FIG. 13, in a case of attempting to acquire the intersection between the projection rays 73a to 73h of the virtual projection apparatus 72 and the projection target object 74, it is assumed that a range of the space recognition by the information processing apparatus 50 is insufficient and a space portion 82 including a right half region 74q of the projection target object 74 cannot be recognized. In this case, the projection points 75a, 75b, 75g, and 75h that are the intersections between the projection rays 73a, 73b, 73g, and 73h and the projection target object 74 can be acquired, but the projection points of the projection rays 73c, 73d, 73e, and 73f intersecting the region 74q of the projection target object 74 cannot be acquired.

Therefore, in a case where there is the projection ray 73 for which the projection point 75 cannot be acquired among the plurality of projection rays 73, the processor 61 determines the position and the shape of the virtual projection surface 77 based on the projection point 75 that is the intersection between the virtual projection target object based on the recognition result of the space and the projection ray 73 for which the projection point 75 cannot be acquired, and the projection point 75 that can be acquired. The virtual projection target object based on the recognition result of the space is, for example, a virtual projection target object corresponding to a portion that cannot be recognized, which is generated based on a portion of the recognized projection target object 74.

Specifically, as shown in FIG. 13, the processor 61 generates the region 74q of the right half projection target object 74 as a virtual projection target object 84 based on the position and the shape of the left half projection target object 74 that can be recognized. The processor 61 acquires projection points 85c, 85d, 85e, and 85f that are intersections between the generated virtual projection target object 84 and the projection rays 73c, 73d, 73e, and 73f. The processor 61 determines the position and the shape of the virtual projection surface 77 based on the projection points 85c, 85d, 85e, and 85f that are the intersections with the virtual projection target object 84 and the projection points 75a, 75b, 75g, and 75h that are the intersections with the projection target object 74.

In a case where there is the projection point 75 that cannot be acquired because a part of the projection target object 74 cannot be recognized, the virtual projection target object 84 is generated based on the recognized projection target object 74, so that it is possible to display the virtual projection surface 77 having a shape close to the actual projection even in a space structure that is difficult to recognize.

### Third Generation Example

Although not shown, in a case where there is the projection ray 73 for which the projection point 75 cannot be acquired among the plurality of projection rays 73, the processor 61 may determine the position and the shape of the virtual projection surface 77 as follows.

The processor 61 may determine the position and the shape of the virtual projection surface 77 based on the projection point 75 that is the intersection between the surface based on the projection point 75 for which the projection point 75 can be acquired among the plurality of projection rays 73 and the projection ray 73 for which the projection point 75 cannot be acquired, and the projection point 75 that can be acquired. The surface based on the projection point 75 that can be acquired is a surface having the same posture as the surface created by the projection point 75 that can be acquired, that is, a tangent plane of the projection target object 74 at the position of the projection point 75 that can be acquired.

For example, the processor 61 generates the tangent plane of the projection target object 74 at the position of the projection point 75 that can be acquired. The processor 61 acquires the projection point 75 that is the intersection between the generated tangent plane and the projection ray 73 for which the projection point 75 cannot be acquired. The processor 61 determines the position and the shape of the virtual projection surface 77 based on the projection point 75 that is the intersection with the tangent plane and the projection point 75 that is the intersection with the projection target object 74. As in the present generation example, even in a case of generating the tangent plane of the projection target object 74 at the position of the projection point 75 that can be acquired, it is possible to display the virtual projection surface 77 having a shape close to the actual projection.

### <Sixth Aspect of Processing of Information Processing Apparatus 50>

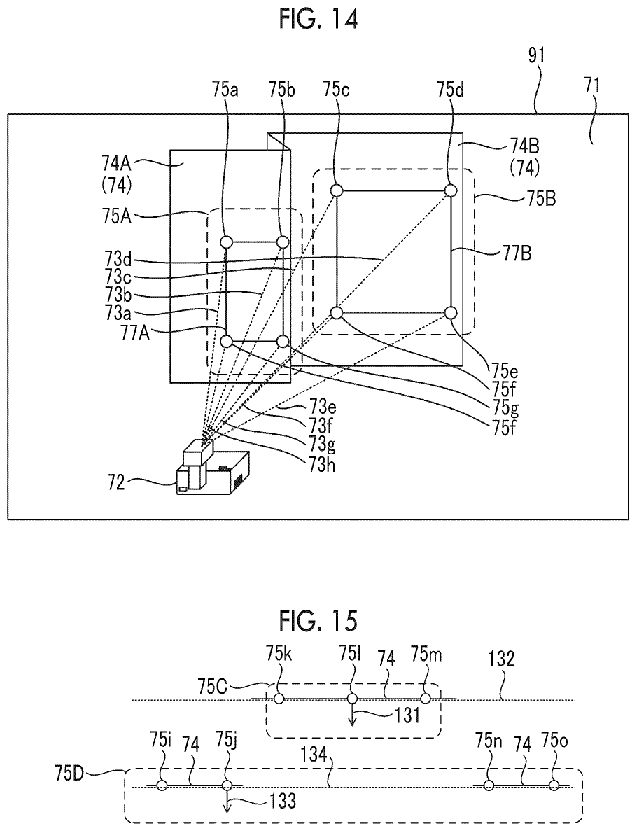

A sixth aspect of processing of the information processing apparatus 50 will be described with reference to FIGS. 14 and 15. FIG. 14 is a diagram showing an example (first grouping) of grouping the acquired plurality of projection points 75. FIG. 15 is a diagram showing an example (second grouping) of grouping the acquired plurality of projection points 75.

The processor 61 of the information processing apparatus 50 groups the acquired plurality of projection points 75 based on a predetermined determination criterion, and determines the position and the shape of the virtual projection surface 77 corresponding to the groups. The “corresponding to the groups” is, for example, for each group. The processor 61 generates a plurality of types of virtual projection surfaces 77 different for each group.

### (First Grouping)

In a case of generating the virtual projection surface 77, for example, as shown in FIG. 14, it is assumed that the projection points 75a to 75h that are the intersections between the projection rays 73a to 73h of the virtual projection apparatus 72 and the projection target object 74 (including projection target portions 74A and 74B) are acquired.

The processor 61 groups the acquired plurality of projection points 75a to 75h based on the recognition result of the space. The recognition result of the space is, for example, a case where two types of projection target portions 74A and 74B having a level difference in the front-rear direction can be recognized as shown in FIG. 14. The processor 61 groups the acquired projection points 75a to 75h into the projection points 75a, 75b, 75g, and 75h acquired on the projection target portion 74A and the projection points 75c, 75d, 75e, and 75f acquired on the projection target portion 74B.

The processor 61 sets, for example, the projection points 75a, 75b, 75g, and 75h that are the intersections between the projection target portion 74A and the projection rays 73a, 73b, 73g, and 73h as a first group 75A, and sets the projection points 75c, 75d, 75e, and 75f that are the intersections between the projection target portion 74B and the projection rays 73c, 73d, 73e, and 73f as a second group 75B.

### (Second Grouping)

In a case of generating the virtual projection surface 77, for example, as shown in FIG. 15, it is assumed that the projection points 75i to 75o are acquired as the intersections with the projection rays. FIG. 15 is a top view of the projection points 75i to 75o as viewed from above (in a direction perpendicular to the projection direction).

In this case, the processor 61 groups the acquired plurality of projection points 75i to 75o based on the projection points 75i to 75o and a normal vector based on the projection target object 74. For example, the processor 61 obtains a normal vector 131 at the projection point 75l that is one point on the projection target object 74, and creates a plane 132 represented by the normal vector 131. In addition, the processor 61 detects a distance between the plane 132 represented by the normal vector 131 and each projection point, and sets projection points 75k, 75l, and 75m close to the plane 132 as a third group 75C.

In addition, the processor 61 obtains a normal vector 133 at the projection point 75j that is one point on the projection target object 74, and creates a plane 134 represented by the normal vector 133. Similarly, the processor 61 detects a distance between the plane 134 represented by the normal vector 133 and each projection point, and sets projection points 75i, 75j, 75n, and 75o close to the plane 134 as a fourth group 75D.

### (Third Grouping)

In a case where the processor 61 cannot recognize, for example, two types of projection target portions 74A and 74B having a level difference in the front-rear direction in FIG. 14, the processor 61 may group the acquired plurality of projection points 75a to 75h based on a distance between the acquired plurality of projection points 75a to 75h. The distance between the projection points 75a to 75h is, for example, a distance between adjacent projection points. The processor 61 groups the projection points 75a to 75h according to the distance between the adjacent projection points.

Specifically, the processor 61 detects a distance between the adjacent projection points 75a and 75b and a distance between the adjacent projection points 75c and 75d. The processor 61 sets the projection points 75a and 75b, between which the distance between the adjacent projection points is close, as the same group, and sets the projection points 75c and 75d, between which the distance between the adjacent projection points is far, as the same group. Similarly, the processor 61 detects a distance between the adjacent projection points 75g and 75h and a distance between the adjacent projection points 75e and 75f. The processor 61 sets the projection points 75g and 75h, between which the distance between the adjacent projection points is close, as the same group as the projection points 75a and 75b, and sets the projection points 75e and 75f, between which the distance between the adjacent projection points is far, as the same group as the projection points 75c and 75d. The processor 61 sets the projection points 75a, 75b, 75g, and 75h as the first group 75A, and sets the projection points 75c, 75d, 75e, and 75f as the second group 75B.

### (Fourth Grouping)

The processor 61 may group the acquired plurality of projection points 75 into the projection points 75 corresponding to the projection target object 74 that is the object present in the space and the projection points 75 corresponding to the virtual projection target object 81 disposed in the virtual space representing the space. For example, in a case where the projection target object 74 and the virtual projection target object 81 are set as the objects in the space, the processor 61 may divide the plurality of projection points 75 into a group including the projection point 75 that is the intersection with the projection target object 74 shown in FIG. 8 and a group including the projection point 75 that is the intersection with the virtual projection target object 81 shown in FIG. 10.

### (Fifth Grouping)

The processor 61 may group the acquired plurality of projection points 75 based on the user instruction. For example, the processor 61 may handle the projection point 75 arbitrarily selected by the user as the same group in response to the instruction of the user.

The projection target object 74 onto which the projection rays 73 are projected is not necessarily a continuous surface (for example, a wall surface), and may be a case where a protrusion such as a column is provided in the middle of the surface. In such a case, it is desirable to minimize the projection to the column portion or to project an important part of the image to the wall surface. Therefore, as in the present aspect, by grouping the projection points 75 for each of the virtual projection surfaces 77 having different states, it is possible to accurately determine a position at which the virtual projection apparatus 72 is installed, an orientation in which the virtual projection apparatus 72 is installed, and the like, and it is possible to bring the projection simulation close to the intention of the user.

### <Seventh Aspect of Processing of Information Processing Apparatus 50>

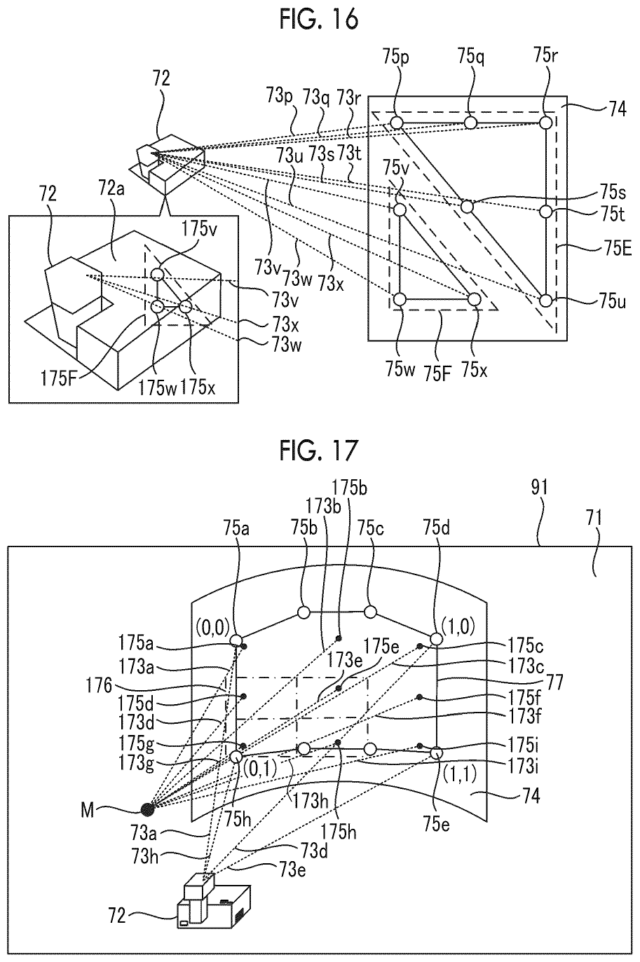

A seventh aspect of processing of the information processing apparatus 50 will be described with reference to FIG. 16. FIG. 16 is a diagram showing a case where the projection rays 73 of the virtual projection apparatus 72 are projected onto the virtual projection apparatus 72 itself.

In a case where at least any of the plurality of projection rays 73 intersects the plurality of projection target objects 74 in the space, the processor 61 of the information processing apparatus 50 groups the acquired plurality of projection points 75 in accordance with the corresponding projection target object 74. The plurality of projection target objects 74 include, for example, a wall surface that is a target object to be projected and a body of the virtual projection apparatus 72 itself that projects the projection rays 73.

Among the projection rays 73 projected from the virtual projection apparatus 72 toward the projection target object 74, there are the projection rays 73 that directly reach the projection target object 74, and there are also the projection rays 73 that are blocked by an object present between the virtual projection apparatus 72 and the projection target object 74. For example, as shown in FIG. 16, among the projection rays 73p to 73x projected from the virtual projection apparatus 72, there are the projection rays 73p to 73u that directly reach the projection target object 74, and there are also the projection rays 73v to 73x that are projected (blocked) onto a part of the body 72a of the virtual projection apparatus 72 before reaching the projection target object 74.

In this case, the processor 61 sets the projection points 75p to 75u that are the intersections between the projection rays 73p to 73u that directly reach the target projection target object 74 to be projected and the projection target object 74 as a fifth group 75E of the same group. In addition, the processor 61 sets the projection points 175v to 175x that are the intersections between the projection rays 73v to 73x projected onto the part of the virtual projection apparatus 72 and the virtual projection apparatus 72 as a sixth group 175F of the same group. In addition, the processor 61 sets the projection points 75v to 75x that are the intersections between the projection rays 73v to 73x that should have been projected onto the target projection target object 74 unless blocked by the virtual projection apparatus 72 and the virtual projection apparatus 72 as a seventh group 75F. The processor 61 obtains a plurality of intersections (intersections with the virtual projection apparatus 72 and the projection target object 74) for one projection light (projection rays 73v to 73x), acquires a plurality of projection points (projection points 175v to 175x and projection points 75v to 75x) corresponding to each of the plurality of intersections, and groups the plurality of projection points into another group.

The processor 61 generates virtual projection image data representing the virtual projection image 91 in which the virtual projection surface 77 is displayed in an aspect corresponding to the groups. The aspect corresponding to the groups is, for example, to distinguish the aspect corresponding to the groups. For example, the aspect corresponding to the group is to color-code the group, to distinguish the display shape of the projection point 75 corresponding to the groups, or the like.

According to the information processing apparatus 50 of the seventh aspect, the projection point 75 of the projection ray 73 that is projected to another object before reaching the target projection target object 74 can be grouped into another group with the projection point 75 of the projection ray 73 that is directly projected onto the target projection target object 74, and can be displayed in an aspect corresponding to the groups. Therefore, it is possible to perform the simulation while understanding how the virtual projection surface 77 determined on the projection target object 74 is, for example, in a broken state.

### <Eighth Aspect of Processing of Information Processing Apparatus 50>

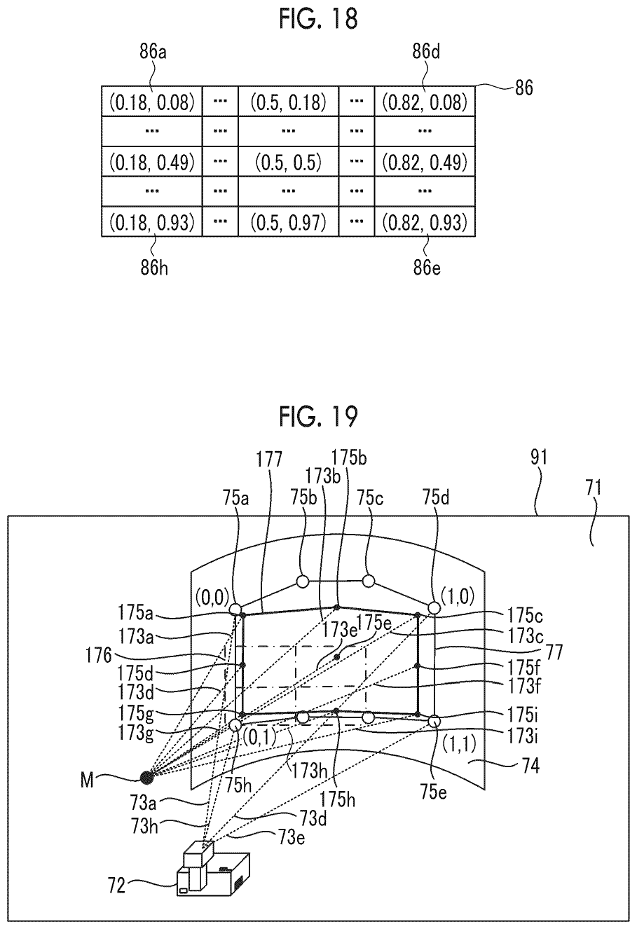

An eighth aspect of processing of the information processing apparatus 50 will be described with reference to FIGS. 17 to 19. FIG. 17 is a diagram showing an example of viewing an image of the virtual projection apparatus 72 from a viewpoint of an assumed viewer. FIG. 18 is a diagram showing an example of correction data 86 for making the image viewed from the viewpoint of the assumed viewer have a specific shape. FIG. 19 is a diagram showing a corrected projection surface 177 corrected by the correction data.

For example, as shown in FIG. 17, it is assumed that the projection rays 73 (for example, the projection rays 73a, 73d, 73e, and 73h) are projected from the virtual projection apparatus 72 toward the projection target object 74, and the projection points 75 (for example, the projection points 75a, 75d, 75e, and 75h) are acquired as the intersections between the projection rays 73 and the projection target object 74. In addition, it is assumed that the image projected from the virtual projection apparatus 72 is viewed by an assumed viewer M who is in a left direction of the virtual projection apparatus 72.

In a case where the shape of the projection target object 74 is non-planar, in a case where the viewer who is at a position (for example, the position of the assumed viewer M) shifted to the left or the right from the front of the projection target object 74 views the image projected onto the projection target object 74, the image appears distorted. Therefore, the information processing apparatus 50 performs processing of correcting the image projected from the virtual projection apparatus 72 onto the projection target object 74 such that the image that is not distorted is visible from the position of the assumed viewer M.

Specifically, the processor 61 of the information processing apparatus 50 generates the correction data 86 (see FIG. 18) for correcting the image projected from the virtual projection apparatus 72 onto the virtual projection surface 77 based on the position and the shape of the virtual projection surface 77 determined by the plurality of projection points 75a, 75d, 75e, and 75h. The correction data 86 is correction data for correcting the image such that the image projected onto the virtual projection surface 77 is visible in a specific shape from a certain viewpoint in the space. The viewpoint is, for example, a viewpoint of the assumed viewer M assumed in the space. The specific shape is a shape (for example, a rectangle) of the image that the virtual projection apparatus 72 attempts to project toward the projection target object 74.

In a case of generating the correction data 86, the processor 61 generates virtual projection image data of the virtual projection image 91 in which a rectangular apparent projection surface 176 visible at a certain distance from the viewpoint of the assumed viewer M is displayed. The certain distance can be set by the user. Therefore, the size of the apparent projection surface 176 can be changed according to the certain distance set by the user. The virtual projection image 91 may display not only the apparent projection surface 176 but also the virtual projection surface 77. The apparent projection surface 176 is an example of a “second virtual projection surface” in the present invention.

The processor 61 obtains points 175a to 175i at which straight lines 173a to 173i extending from the viewpoint of the assumed viewer M and passing through points on the apparent projection surface 176 intersect the projection target object 74. The points 175a to 175i are points for determining a corrected projection surface 177 (see FIG. 19) on the projection target object 74 corresponding to the rectangular apparent projection surface 176 in the viewpoint of the assumed viewer M.

The correction data 86 is correction data for correcting the position of the virtual projection surface 77 generated on the projection target object 74 by being projected from the virtual projection apparatus 72 to be the position of the corrected projection surface 177 on the projection target object 74 as viewed from the assumed viewer M. Here, among the points 175a to 175i, for example, correction data is considered for points 175a, 175c, 175i, and 175g corresponding to the projection points 75a, 75d, 75e, and 75h that are the intersections between the projection rays 73a, 73d, 73e, and 73h and the projection target object 74.

The correction data 86 is created based on a correspondence relationship between pixels of the image and coordinates on the virtual projection surface 77. In a case where the coordinate values of the projection points 75a, 75d, 75e, and 75h are set to (0, 0), (1, 0), (1, 1), and (0, 1), the coordinate values of the corresponding points 175a, 175c, 175i, and 175g are (0.18, 0.08), (0.82, 0.08), (0.82, 0.93), and (0.18, 0.93). Therefore, the correction data value for setting the position of the virtual projection surface 77 to the position of the corrected projection surface 177 is such that the projection point 75a of the virtual projection surface 77 is (0.18, 0.08), the projection point 75d is (0.82, 0.08), the projection point 75e is (0.82, 0.93), and the projection point 75h is (0.18, 0.93). These correction data values are generated as data 86a, 86d, 86e, and 86h in the correction data 86 shown in FIG. 18. A data size of the correction data 86 may be automatically set to be larger as the number of pixels of the image is larger, for example, or may be set by the user.

The processor 61 generates virtual projection image data of the virtual projection image 91 in which a state where the image of the corrected projection surface 177 corrected based on the generated correction data 86 is projected onto the projection target object 74 is displayed. As shown in FIG. 19, the processor 61 may display the corrected projection surface 177 in the virtual projection image 91 together with the apparent projection surface 176.

The viewer who views the image projected from the projection apparatus 10 is not necessarily a viewer who views the image from near the position where the projection apparatus 10 is installed, and may view the image from an oblique direction with respect to the projection surface away from the position of the projection apparatus 10. In this case, in a case where the shape of the projection target object is not planar, the image on the projection surface appears distorted to the viewer who views the image from the oblique direction. On the other hand, as in the present aspect, by generating the correction data 86, even in a case where the viewer views the image from a certain viewpoint in the space, an image that is not distorted can be created for the viewer, and the created image that is not distorted can be displayed on the projection target object. In addition, in a case where it is assumed that the viewer views the image from a plurality of directions, the appearance as viewed from a position other than an ideal viewing position (for example, near the virtual projection apparatus 72) can be verified in advance.

### <Ninth Aspect of Processing of Information Processing Apparatus 50>

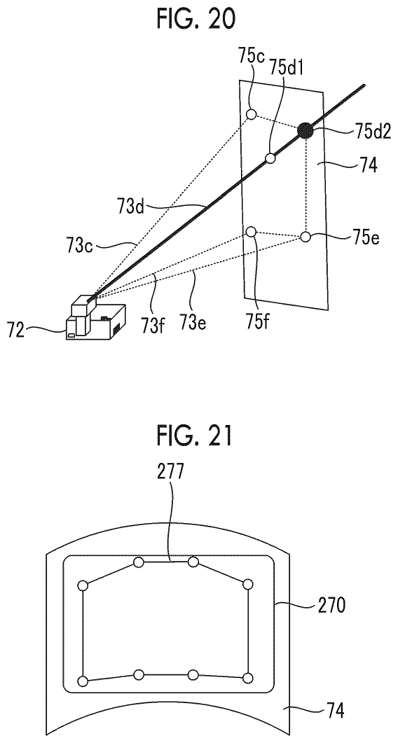

A ninth aspect of processing of the information processing apparatus 50 will be described with reference to FIG. 20. FIG. 20 is a diagram showing an example of changing the position of the recognized projection point 75.

As shown in FIG. 20, it is assumed that the processor 61 of the information processing apparatus 50 acquires, as the intersections between the projection rays 73c, 73d, 73e, and 73f projected from the virtual projection apparatus 72 and the projection target object 74, for example, the projection points 75c, 75d1, 75e, and 75f. In this case, in a case where the user determines that the position of the projection point 75d1 is an inappropriate position as compared with the positions of the other projection points 75c, 75e, and 75f, the user can change the position of the projection point 75d1 by operating the information processing apparatus 50. The processor 61 performs processing of, for example, moving the position of the projection point 75d1 to the position of the projection point 75d2 in response to the user operation. In a case where the position of the projection point is changed by the user operation, the processor 61 may change and display the color of the projection point or the thickness of the projection ray on the change target during the change operation. In addition, the processor 61 may be able to add or delete the projection point based on the user operation.

The projection point 75 obtained from the intersection between the projection rays 73 and the projection target object 74 in the space may be acquired at a position different from the position that should be acquired, due to, for example, inaccuracy in the recognition of the structure of the space. As in the present aspect, by moving the position of the projection point 75d1 to a position (projection point 75d2) considered appropriate by the user, it is possible to perform the projection simulation close to the intention of the user. In addition, for example, even in a case where the virtual projection point is acquired by estimating the space structure, the projection point may not be created as intended by the user. Therefore, by allowing the user to delete or create the projection point, it is possible to perform the projection simulation close to the intention of the user.

### <Tenth Aspect of Processing of Information Processing Apparatus 50>

A tenth aspect of processing of the information processing apparatus 50 will be described with reference to FIG. 21. FIG. 21 is a diagram showing an example of display of the virtual projection surface using a transmissive AR glass.

The processor 61 of the information processing apparatus 50 determines the position of the virtual projection apparatus 72 in the space in which the projection is performed by the projection apparatus 10. In addition, the processor 61 acquires a plurality of projection points 75 that are intersections between the projection rays 73 of the virtual projection apparatus 72 and the projection target object 74 in the space. The processor 61 determines the position and the shape of the virtual projection surface 77 based on the acquired plurality of projection points 75. These processes are the same as the processes of the above-described embodiment.

The processor 61 generates virtual projection surface image data representing the determined virtual projection surface 77. The processor 61 outputs the generated virtual projection surface image data to the display destination. The output destination in the present aspect is, for example, a transmissive augmented reality (AR) glass. For example, as shown in FIG. 21, the processor 61 optically combines and displays a virtual projection surface image 277 representing the virtual projection surface 77 in a visual field 270 that the user is viewing, that is, on the transmissive AR glass worn by the user.

According to the information processing apparatus 50 of the tenth aspect, in a case where a user who performs projection by the virtual projection apparatus 72 installs the virtual projection apparatus 72 at a position in an installation space, it is possible to easily and more accurately simulate a shape in which the virtual projection surface image 277 of the virtual projection apparatus 72 is projected onto the projection target object.

### <Eleventh Aspect of Processing of Information Processing Apparatus 50>

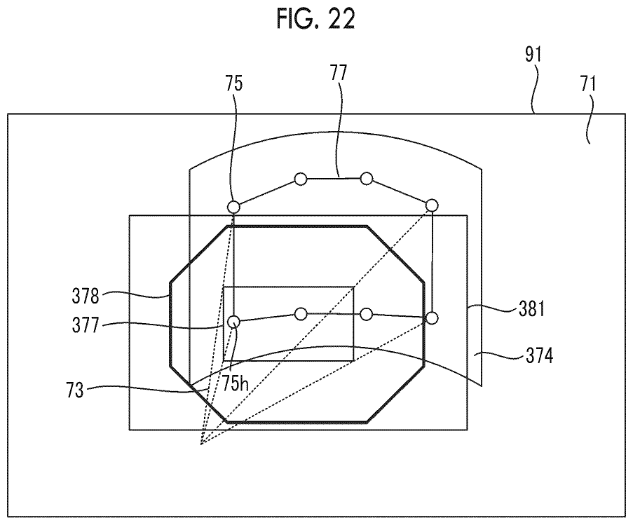

The eleventh aspect of processing of the information processing apparatus 50 will be described with reference to FIG. 22. FIG. 22 is a diagram showing a display example of a lens shift range of the virtual projection apparatus 72.

The processor 61 of the information processing apparatus 50 acquires space image data representing the space image 71 of the space in which the projection is performed by the projection apparatus 10. In addition, the processor 61 determines the position of the virtual projection apparatus 72 and the position of a virtual projection target object 374 that is a projection target object of the virtual projection apparatus 72 in the space.

In addition, the processor 61 acquires a plurality of projection points 75 that are intersections between the projection rays 73 of the virtual projection apparatus 72 and the projection target object 74, and determines the position and the shape of the virtual projection surface 77 based on the acquired plurality of projection points 75. In addition, the processor 61 sets a standard projection target object 381 between the virtual projection apparatus 72 and the virtual projection target object 374.

In addition, the processor 61 sets a rectangular projection surface visible at a certain distance from the virtual projection apparatus 72 among the projection surfaces of the projection rays 73 projected from the virtual projection apparatus 72 toward the virtual projection target object 374 as a standard projection surface 377.

In addition, the processor 61 determines a range in which the virtual projection apparatus 72 can perform lens shift as a lens shift range 378 in which the standard projection surface 377 can be shifted on the standard projection target object 381. The lens shift range 378 is a range in which a center point of the standard projection surface 377 can be shifted. The position of the standard projection target object 381 may be automatically determined or may be determined by the user. In addition, the standard projection target object 381 may not be displayed.

The processor 61 generates a virtual projection image 91 in which the virtual projection apparatus 72, the virtual projection surface 77, and the lens shift range 378 disposed between the virtual projection apparatus 72 and the virtual projection surface 77 are displayed on the space image 71 represented by the space image data. The processor 61 acquires virtual projection image data representing the virtual projection image 91, and outputs the acquired virtual projection image data to, for example, a display unit (touch panel 51) provided in the information processing apparatus 50. By displaying the lens shift range 378 disposed between the virtual projection apparatus 72 and the virtual projection surface 77, the user can easily recognize the range in which the virtual projection apparatus 72 can perform lens shift.

In the present aspect, the configuration is not limited to a configuration in which the plurality of projection points 75 that are the intersections between the plurality of projection rays 73 of the virtual projection apparatus 72 and the object (for example, the virtual projection target object 374) in the space image 71 are acquired, and the position and the shape of the virtual projection surface 77 are determined based on the plurality of projection points 75. For example, the processor 61 may determine the position and the shape of the virtual projection surface 77 to have a planar shape based on the recognition result of the virtual projection target object 374.

The control method described in the above embodiment can be implemented by executing a control program prepared in advance via a computer. The present control program is executed by being recorded in a computer-readable storage medium and being read out from the storage medium. In addition, the present control program may be provided in a form of being stored in a non-transitory storage medium, such as a flash memory, or may be provided via a network, such as the Internet. The computer that executes the present control program may be included in the control device, may be included in an electronic apparatus such as a smartphone, a tablet terminal, or a personal computer that can communicate with the control device, or may be included in a server device that can communicate with the control device and the electronic apparatus.

As described above, at least the following matters are described in the present specification.

(1)

An information processing apparatus including:
a processor,
in which the processor is configured to:
acquire first image data obtained by imaging a space;
determine a position of a virtual projection apparatus in the space;
acquire a plurality of projection points that are intersections between a plurality of projection rays of the virtual projection apparatus and an object in the space, and determine a position and a shape of a virtual projection surface based on the plurality of projection points;
generate second image data representing a second image in which the virtual projection surface is displayed on a first image represented by the first image data; and
output the second image data to an output destination.
   (2)

The information processing apparatus according to (1),
in which the object includes a virtual object disposed in a virtual space representing the space.
   (3)

The information processing apparatus according to (1) or (2),
in which the processor is configured to determine a number of the projection points to be acquired based on a distance between the virtual projection apparatus and the object.
   (4)

The information processing apparatus according to any one of (1) to (3),
in which the processor is configured to determine a number of the projection points to be acquired based on at least one of a recognition result of the space and a user operation.
   (5)

The information processing apparatus according to any one of (1) to (4),
in which the processor is configured to perform a user notification in a case where there is a projection ray for which the projection point is not capable of being acquired among the plurality of projection rays.
   (6)

The information processing apparatus according to any one of (1) to (5),
in which the processor is configured to, in a case where there is a projection ray for which the projection point is not capable of being acquired among the plurality of projection rays, determine the position and the shape of the virtual projection surface based on the projection points that are capable of being acquired.
   (7)

The information processing apparatus according to any one of (1) to (6),
in which the processor is configured to, in a case where there is a projection ray for which the projection point is not capable of being acquired among the plurality of projection rays, determine the position and the shape of the virtual projection surface based on a projection point that is an intersection between a surface based on the projection points that are capable of being acquired and the projection ray for which the projection point is not capable of being acquired, and the projection points that are capable of being acquired.
   (8)

The information processing apparatus according to any one of (1) to (7),
in which the processor is configured to, in a case where there is a projection ray for which the projection point is not capable of being acquired among the plurality of projection rays, determine the position and the shape of the virtual projection surface based on a projection point that is an intersection between a virtual object based on a recognition result of the space and the projection ray for which the projection point is not capable of being acquired, and the projection points that are capable of being acquired.
   (9)

The information processing apparatus according to any one of (1) to (8),
in which the processor is configured to:
execute first processing of determining the position and the shape of the virtual projection surface by assuming that a projection target surface of the object is planar, and second processing of determining the position and the shape of the virtual projection surface by assuming that the projection target surface of the object is non-planar; and
determine the position and the shape of the virtual projection surface based on the plurality of projection points in the second processing.
   (10)

The information processing apparatus according to any one of (1) to (9),
in which the processor is configured to group the acquired plurality of projection points, and determine the position and the shape of the virtual projection surface in accordance with the groups.
   (11)

The information processing apparatus according to (10),
in which the processor is configured to group the acquired plurality of projection points based on a recognition result of the space.
   (12)

The information processing apparatus according to (10),
in which the processor is configured to group the acquired plurality of projection points based on a distance between the acquired plurality of projection points.
   (13)

The information processing apparatus according to (10),
in which the processor is configured to group the acquired plurality of projection points based on the projection points and a normal vector based on the object.
   (14)

The information processing apparatus according to (10),
in which the object includes a physical object present in the space and a virtual object disposed in a virtual space representing the space, and
the processor is configured to group the acquired plurality of projection points into projection points corresponding to the physical object and projection points corresponding to the virtual object.
   (15)

The information processing apparatus according to (10),
in which the processor is configured to group the acquired plurality of projection points based on a user instruction.
   (16)

The information processing apparatus according to (10),
in which the processor is configured to, in a case where at least any of the plurality of projection rays intersects a plurality of objects in the space, group the acquired plurality of projection points in accordance with corresponding objects.
   (17)

The information processing apparatus according to any one of (10) to (16),
in which the processor is configured to generate the second image data representing the second image in which the virtual projection surface is displayed in an aspect corresponding to the groups.
   (18)

The information processing apparatus according to any one of (10) to (17),
in which the processor is configured to generate correction data for correcting an image projected from the virtual projection apparatus onto the virtual projection surface, based on the position and the shape of the determined virtual projection surface.
   (19)

The information processing apparatus according to (18),
in which the correction data is correction data for correcting the image such that the image projected onto the virtual projection surface is visible in a specific shape from a viewpoint in the space, and
in which the processor is configured to generate the second image data representing the second image in which the second virtual projection surface having the specific shape is displayed.
   (20)

An information processing apparatus including:
a processor,
in which the processor is configured to:
acquire first image data obtained by imaging a space;
determine a position of a virtual projection apparatus in the space;
determine a position and a shape of a virtual projection surface;
determine a lens shift range in which a lens shift of the virtual projection apparatus is possible;
generate second image data representing a second image in which the virtual projection apparatus, the virtual projection surface, and the lens shift range disposed between the virtual projection apparatus and the virtual projection surface are displayed on a first image represented by the first image data; and
output the second image data to an output destination.
   (21)

An information processing apparatus including:
a processor,
in which the processor is configured to:
determine a position of a virtual projection apparatus in a space;
acquire a plurality of projection points that are intersections between a plurality of projection rays of the virtual projection apparatus and an object in the space, and determine a position and a shape of a virtual projection surface based on the plurality of projection points;
generate image data representing the virtual projection surface; and
output the image data to a display destination.
   (23)

An information processing method executed by a processor of an information processing apparatus, the method including:
acquiring first image data obtained by imaging a space;
determining a position of a virtual projection apparatus in the space;
acquiring a plurality of projection points that are intersections between a plurality of projection rays of the virtual projection apparatus and an object in the space, and determining a position and a shape of a virtual projection surface based on the plurality of projection points;
generating second image data representing a second image in which the virtual projection surface is displayed on a first image represented by the first image data; and
outputting the second image data to an output destination.
   (24)

A non-transitory computer-readable storage medium storing an information processing program causing a processor of an information processing apparatus to execute a process including:
acquiring first image data obtained by imaging a space;
determining a position of a virtual projection apparatus in the space;
acquiring a plurality of projection points that are intersections between a plurality of projection rays of the virtual projection apparatus and an object in the space, and determining a position and a shape of a virtual projection surface based on the plurality of projection points;
generating second image data representing a second image in which the virtual projection surface is displayed on a first image represented by the first image data; and
outputting the second image data to an output destination.

Although various embodiments have been described above, it is needless to say that the present invention is not limited to such examples. It is apparent that those skilled in the art may perceive various modification examples or correction examples within the scope disclosed in the claims, and those examples are also understood as falling within the technical scope of the present invention. In addition, each constituent in the embodiment may be used in any combination without departing from the gist of the invention.

The present application is based on Japanese Patent Application (JP2023-140988) filed on Aug. 31, 2023, the content of which is incorporated in the present application by reference.

### EXPLANATION OF REFERENCES

1: projection section
2: operation reception section
2A, 3A: hollow portion
2a, 2b, 3a, 3c, 15a: opening
4: control device
4a, 62: memory
6: projection object
10: projection apparatus
11: projection range
12: optical modulation unit
15: housing
21: light source
22: optical modulation portion
23: projection optical system
24: control circuit
31: second optical system
32, 122: reflective member
33: third optical system
34: lens
50: information processing apparatus
51: touch panel
61: processor
63: communication interface
64: user interface
65: sensor
69: bus
71: space image
72: virtual projection apparatus
72a: body
73, 73a to 73h, 73p to 73x: projection ray
75, 75a to 75x: projection point
74: projection target object
74A, 74B: projection target portion
74p, 74q: region
75A: first group
75B: second group
75C: third group
75D: fourth group
75E: fifth group
75F: seventh group
76a: one point
77: virtual projection surface
81, 84, 374: virtual projection target object
82: space portion
86: correction data
86a, 86d, 86e, 86h: data
91: virtual projection image
101: body part
102: first member
103: second member
104: projection direction changing mechanism
105: shift mechanism
106: optical unit
121: first optical system
131, 133: normal vector
132, 134: plane
173a to 173i: straight line
175a to 175i: point
175F: sixth group
176: apparent projection surface
177: corrected projection surface
277: virtual projection surface image
377: standard projection surface
378: lens shift range
381: standard projection target object
G1: image

What is claimed is:

1. An information processing apparatus comprising:
a processor,
wherein the processor is configured to:
acquire first image data obtained by imaging a space;
determine a position of a virtual projection apparatus in the space;
acquire a plurality of projection points that are intersections between a plurality of projection rays of the virtual projection apparatus and an object in the space, and determine a position and a shape of a virtual projection surface based on the plurality of projection points;
generate second image data representing a second image in which the virtual projection surface is displayed on a first image represented by the first image data; and
output the second image data to an output destination.

2. The information processing apparatus according to claim 1,
wherein the object includes a virtual object disposed in a virtual space representing the space.

3. The information processing apparatus according to claim 1,
wherein the processor is configured to determine a number of the projection points to be acquired based on a distance between the virtual projection apparatus and the object.

4. The information processing apparatus according to claim 1,
wherein the processor is configured to determine a number of the projection points to be acquired based on at least one of a recognition result of the space and a user operation.

5. The information processing apparatus according to claim 1,
wherein the processor is configured to perform a user notification in a case where there is a projection ray for which the projection point is not capable of being acquired among the plurality of projection rays.

6. The information processing apparatus according to claim 1,
wherein the processor is configured to, in a case where there is a projection ray for which the projection point is not capable of being acquired among the plurality of projection rays, determine the position and the shape of the virtual projection surface based on the projection points that are capable of being acquired.

7. The information processing apparatus according to claim 1,
wherein the processor is configured to, in a case where there is a projection ray for which the projection point is not capable of being acquired among the plurality of projection rays, determine the position and the shape of the virtual projection surface based on a projection point that is an intersection between a surface based on the projection points that are capable of being acquired and the projection ray for which the projection point is not capable of being acquired, and the projection points that are capable of being acquired.

8. The information processing apparatus according to claim 1,
wherein the processor is configured to, in a case where there is a projection ray for which the projection point is not capable of being acquired among the plurality of projection rays, determine the position and the shape of the virtual projection surface based on a projection point that is an intersection between a virtual object based on a recognition result of the space and the projection ray for which the projection point is not capable of being acquired, and the projection points that are capable of being acquired.

9. The information processing apparatus according to claim 1,
wherein the processor is configured to:
execute first processing of determining the position and the shape of the virtual projection surface by assuming that a projection target surface of the object is planar, and second processing of determining the position and the shape of the virtual projection surface by assuming that the projection target surface of the object is non-planar; and
determine the position and the shape of the virtual projection surface based on the plurality of projection points in the second processing.

10. The information processing apparatus according to claim 1,
wherein the processor is configured to group the acquired plurality of projection points, and determine the position and the shape of the virtual projection surface in accordance with the groups.

11. The information processing apparatus according to claim 10,
wherein the processor is configured to group the acquired plurality of projection points based on a recognition result of the space.

12. The information processing apparatus according to claim 10,
wherein the processor is configured to group the acquired plurality of projection points based on a distance between the acquired plurality of projection points.

13. The information processing apparatus according to claim 10,
wherein the processor is configured to group the acquired plurality of projection points based on the projection points and a normal vector based on the object.

14. The information processing apparatus according to claim 10,
wherein the object includes a physical object present in the space and a virtual object disposed in a virtual space representing the space, and
the processor is configured to group the acquired plurality of projection points into projection points corresponding to the physical object and projection points corresponding to the virtual object.

15. The information processing apparatus according to claim 10,
wherein the processor is configured to group the acquired plurality of projection points based on a user instruction.

16. The information processing apparatus according to claim 10,
wherein the processor is configured to, in a case where at least any of the plurality of projection rays intersects a plurality of objects in the space, group the acquired plurality of projection points in accordance with corresponding objects.

17. The information processing apparatus according to claim 10,
wherein the processor is configured to generate the second image data representing the second image in which the virtual projection surface is displayed in an aspect corresponding to the groups.

18. The information processing apparatus according to claim 1,
wherein the processor is configured to generate correction data for correcting an image projected from the virtual projection apparatus onto the virtual projection surface, based on the position and the shape of the determined virtual projection surface.

19. The information processing apparatus according to claim 18,
wherein the correction data is correction data for correcting the image such that the image projected onto the virtual projection surface is visible in a specific shape from a viewpoint in the space, and
wherein the processor is configured to generate the second image data representing the second image in which the second virtual projection surface having the specific shape is displayed.

20. An information processing apparatus comprising:
a processor,
wherein the processor is configured to:
determine a position of a virtual projection apparatus in a space;
acquire a plurality of projection points that are intersections between a plurality of projection rays of the virtual projection apparatus and an object in the space, and determine a position and a shape of a virtual projection surface based on the plurality of projection points;
generate image data representing the virtual projection surface; and
output the image data to a display destination.

21. An information processing method executed by a processor of an information processing apparatus, the method comprising:
acquiring first image data obtained by imaging a space;
determining a position of a virtual projection apparatus in the space;
acquiring a plurality of projection points that are intersections between a plurality of projection rays of the virtual projection apparatus and an object in the space, and determining a position and a shape of a virtual projection surface based on the plurality of projection points;
generating second image data representing a second image in which the virtual projection surface is displayed on a first image represented by the first image data; and
outputting the second image data to an output destination.

22. A non-transitory computer-readable storage medium storing an information processing program causing a processor of an information processing apparatus to execute a process comprising:
acquiring first image data obtained by imaging a space;
determining a position of a virtual projection apparatus in the space;
acquiring a plurality of projection points that are intersections between a plurality of projection rays of the virtual projection apparatus and an object in the space, and determining a position and a shape of a virtual projection surface based on the plurality of projection points;
generating second image data representing a second image in which the virtual projection surface is displayed on a first image represented by the first image data; and
outputting the second image data to an output destination.
